(19) United States
(12) Patent Application Publication
(10) Pub. No.: US 2012/0273663 A1
(43) Pub. Date: Nov. 1, 2012

(54) LUMINAIRE AND LANTERN

(75) Inventor: Malcolm Alexander Young, Strathfield (AU)

(73) Assignee: Secure Manufacturing Pty Ltd, Belrose (AU)

(21) Appl. No.: 13/496,186

(22) PCT Filed: Sep. 13, 2010
(86) PCT No.: PCT/AU2010/001187

§ 371 Date: May 24, 2012

(30) Foreign Application Priority Data
Sep. 14, 2009 (AU) 2009904427

(51) Int. Cl. F21V 5/04; F21V 13/02; F21V 3/00; F21V 13/04; G01J 1/42

(52) U.S. Cl. 250/216; 362/311.02; 362/308; 362/555

(57) ABSTRACT

The present disclosure provides an artificial lighting device (100) that utilises at least one light source (150) disposed in an optical cavity (105) defined by an internal surface of a hollow structural housing. A first opaque portion (140) of the housing is adapted to provide a reflector in the interior of the housing, such that light incident on that first opaque portion (140) from the light source (150) in the cavity (105) in the interior of the housing is reflected towards the cavity (105). A second opaque portion (120) of the housing has a plurality of apertures between the interior and exterior of the housing. Thus, light from the light source (150) is reflected within the cavity (105) by at least the first opaque portion (140) of the housing and is able to be transmitted from the cavity (105), through the plurality of apertures, to the exterior of the housing. The lighting device (100) also includes a lens unit (110) that is aligned with the plurality of apertures.

### REFERENCE TO RELATED PATENT APPLICATION(S)

This application claims priority from Australian Provisional Patent Application No. 2009904427, titled “An Improved Luminaire and Lantern”, filed 14 Sep. 2009, which is hereby incorporated by reference in its entirety as if fully set forth herein.

### TECHNICAL FIELD

The present invention relates generally to artificial lighting and, in particular, to electric lighting devices, including luminaires and lanterns used for traffic signals.

### BACKGROUND

Artificial lighting devices are used to provide light at a desired intensity and location, and can be fixed, such as street lights, or mobile, such as hand-held torches. Artificial lights are used to illuminate dark areas, such as interiors of buildings or outdoor spaces at night. Illuminating dark areas can be used, for example, to facilitate navigation, improve security and safety, extend working and production hours, and increase leisure time. Examples of artificial lights include street lights, torches, floodlights, fluorescent is light globes, and filament light globes.

In some applications, artificial lights are utilised to provide illumination of a predetermined area, such as a street or path. Controlling the intensity and/or the direction of light from an artificial lighting device can also be utilised to create atmosphere or ambience, such as in a restaurant. Another application of artificial lighting devices is to focus light in a predetermined manner to guide and control the movement of people, vessels, and vehicles. Such lighting devices include, for example, beacons, warning lights, lighthouses, headlights, tail-lights, and traffic signal lanterns.

Traditionally, signal lanterns have used incandescent filament lamps or quartz halogen lamps as a source of artificial light. The lamp is fitted at the focus of a parabolic reflector and the front of the reflector is fitted with a coloured lens that determines the colour of the signal. More recently, signal lanterns have been implemented using light emitting diodes (LEDs) as a light source. The LEDs are commonly fitted to a flat circular printed circuit board and require no reflector. The colour of a LED type of lantern is determined by the intrinsic properties of the LEDs used. A lens may be fitted to such signal lanterns for environmental protection or for optical purposes.

The LED lanterns, when compared with lanterns utilising incandescent filament lamps, have the advantage of lower power consumption and longer life, but suffer the disadvantage of poor appearance when used with certain accessories. LED lanterns are typically more expensive to produce, because of the greater cost and number of component parts required.

Additionally, the traditional LED type lantern requires many individual LEDs to is be used to give the appearance of a solid disc of colour, as individual LEDs provide a relatively discrete source of light. For a 200 mm diameter lantern, approximately 280 LEDs are needed to meet general requirements for quality of light and provide the appearance of a single light source. It is common, however, perhaps for economic reasons, to utilise as few as one quarter of this number of LEDs. Utilising such a decreased number of LEDs results in a poor and confusing appearance, as only a relatively small area of the lantern produces light, resulting in a small “flashed area”. The reduced number of LED light sources used in the lantern results in a relatively small area of the lantern diameter appearing as a source of light. The poor appearance of such an implementation is worsened when one or more of the LEDs fail. The poor appearance is further degraded when one or more louvres are fitted in front of the lantern. In the preferred implementation in which 280 LEDs are utilised, a single louvre blocks a relatively small percentage of the available artificial light. However, when only 70 LEDs are utilised, the same single louvre blocks a substantially larger percentage of the available artificial light.

It is desirable to reduce power consumption of artificial lighting devices, for environmental and economic reasons. LED type lanterns, with power consumption of approximately 5 to 10 Watts, are more efficient than incandescent type lanterns, which have power consumption in the range of 30 to 67 Watts. However, a further power reduction would be advantageous, especially when power is supplied from a photovoltaic power source.

Current LED lanterns use a large number of relatively low output LEDs to achieve a required total light output. The LEDs used are manufactured using transparent epoxy resin encapsulation. The epoxy resin encapsulation softens at a low temperature, which can cause the LEDs to suffer mechanical damage. More modern LEDs use higher is temperature materials that do not suffer from this mode of failure and additionally have much higher light output. These superior LEDs are difficult to use, however, since the greater light output of the superior LEDs means that fewer LEDs must be used, which results in a poorer signal appearance.

Current lanterns use light sources that suffer a reduction in light output as those light sources age. This loss of light, which is often called lumen depreciation, causes designers to make lanterns that produce excessive light and consume excessive power in the early part of the lanterns' lives. The excess light can be so great as to be harmful and the extra power is just wasted and also reduces the lifetime of the LED. For some kinds of LED, especially those used in red and yellow signals, the light output depends strongly on operating temperature. The operating temperature is further affected by the local ambient temperature and by heating due to solar radiation.

This again leads designers to compensate by applying extra power to the LEDs. Applying extra power to the LEDs exacerbates the power consumption and lumen depreciation problems. The combined effect is large and makes the design of red lanterns particularly problematic. LEDs work most efficiently when cold and least efficiently when the LEDs are hot, whereas the required light output is greatest during the day and least during the night.

Thus, a need exists to provide an improved artificial lighting device.

### SUMMARY

The present disclosure provides an artificial lighting device that utilises at least one light source disposed in an optical cavity defined by an internal surface of a hollow structural housing. A first opaque portion of the housing is adapted to provide a reflector in the interior of the housing, such that light incident on that first opaque portion from the light source in the cavity in the interior of the housing is reflected towards the cavity. A second opaque portion of the housing has a plurality of apertures between the interior and exterior of the housing. Thus, light from the light source is generally reflected within the cavity and is able to be transmitted from the cavity, through the plurality of apertures, to the exterior of the housing.

According to a first aspect of the present disclosure, there is provided an electric lighting device, comprising: a hollow structural housing having an internal surface defining a cavity; a light-emitting diode (LED) light source disposed within the cavity in the interior of the housing; a first opaque portion of the housing adapted to provide a reflector in the interior of the housing, a second opaque portion of the housing having a plurality of apertures between the interior and exterior of the housing; and a lens unit aligned with the plurality of apertures.

According to a second aspect of the present disclosure, there is provided a lighting device, comprising: a hollow structural housing having an internal surface defining a cavity; a light source disposed within the cavity in the interior of the housing; a first opaque portion of the housing adapted to provide a reflector in the interior of the housing, a second opaque portion of the housing having a plurality of apertures between the interior and exterior of the housing; and a lens unit aligned with the plurality of apertures.

In one embodiment, the lighting device is electric and the light source is implemented using at least one of a light-emitting diode, light emitting plasma, a tungsten filament, and an optical fibre.

Other aspects of the invention are also disclosed.

### BRIEF DESCRIPTION OF THE DRAWINGS

At least one embodiment of the present disclosure will now be described with reference to the drawings, in which:

FIG. 1 shows an artificial lighting device in accordance with one embodiment of the present disclosure;

FIG. 2 shows one embodiment of a perforated reflector plate for use in a lighting device of the present disclosure;

FIG. 3 shows traces of light rays incident upon a perforated reflector plate used in a lighting device of the present disclosure;

FIG. 4 shows an electric lighting device in accordance with an embodiment of the present disclosure;

FIG. 5 shows an expanded view of a region of the housing of the electric lighting device of FIG. 4;

FIGS. 6A to 6C illustrate embodiments of an electric lighting device with a housing in the form of a conventional fluorescent light tube;

FIG. 7 shows a traffic lantern arrangement embodying an electric lighting device of the present disclosure; and

FIGS. 8A to 8C illustrate embodiments in which a plurality of electric lighting devices are arranged to form display units.

### DETAILED DESCRIPTION

Where reference is made in any one or more of the accompanying drawings to steps and/or features that have the same reference numerals, those steps and/or features have for the purposes of this description the same function(s) or operation(s), unless the contrary intention appears.

The present disclosure provides an artificial lighting device that utilises at least one light source disposed in an optical cavity defined by an internal surface of a hollow structural housing. A first opaque portion of the housing is adapted to provide a reflector in the interior of the housing, such that light incident on that first opaque portion from the light source in the cavity in the interior of the housing is reflected towards the cavity. A second opaque portion of the housing has a plurality of apertures between the interior and exterior of the housing. Thus, light from the light source is generally reflected within the cavity and is able to be transmitted from the cavity, through the plurality of apertures, to the exterior of the housing.

The lighting device also includes a lens unit that is aligned with the plurality of apertures. Depending on the application, the lens unit can be used to modify light received from the cavity through the plurality of apertures, such as, for example, focussing or colouring the light. In one embodiment, each one of the plurality of apertures in the second opaque portion of the housing is aligned with at least one lens or lens element in the lens unit. In one embodiment, the lens unit is integrally formed with an exterior surface of the second opaque portion of the housing. In an alternative embodiment, the lens unit is coupled to the housing. In a further alternative embodiment, the lens unit is adjacent to an exterior surface of the housing.

In one embodiment, the artificial lighting device is an electric lighting device. The light source may be implemented by using one or more light-emitting diodes (LEDs), to such as LEDs utilising InGaN or AlInGaP, or by LED excited phosphors in which light is emitted by a phosphor that has been excited by a short wavelength LED, such as a blue LED or an ultra violet LED. When a plurality of LEDs are utilised, the placement of the LEDs with respect to each may vary considerably with little effect on the overall performance of the lighting device, due to the nature of the reflections within the cavity. In another embodiment, the light source is implemented using a light-emitting plasma (LEP), in which a plasma is formed/excited electrically or by means of a coupled radio frequency energy. In another embodiment, the light source is implemented using a tungsten filament incandescent bulb. In a further embodiment, the light source is implemented using light emitted from an end of one or more optical fibres, wherein the end of each optical fibre is zo located within the cavity. In a yet further embodiment, the light source is implemented using external light guided into said cavity, such as sunlight guided into said cavity by a waveguide, wherein an opening of said waveguide is located within the cavity and light emitted from the opening functions as a light source disposed within the cavity. In another embodiment, a light source is implemented using an electrical discharge source, such as one or more fluorescent tubes, high pressure sodium lamps, or neon tubes. In an embodiment in which the light source is implemented using LEDs, the apparent expansion in area of the light source means that fewer LEDs can be used, thus saving on power and expense.

In operation, light from the at least one light source is reflected within the optical cavity to create an apparent expansion in area of the light source. In a luminaire implemented using an open reflector assembly, almost all the light reflected from the reflector leaves the luminaire through a single, relatively large aperture. In contrast, an embodiment of a lighting device in accordance with the present disclosure is configured such that a minority of light that is incident on the second opaque portion of the housing leaves the lighting device. The relative amount of the internal surface of the housing that is covered by apertures will depend on the particular application in order to deliver a desired effect.

In some arrangements, approximately 0.1% to 50% of the total luminous flux is reflected from the reflective internal surface of the housing of the lighting device leaves the lighting device via the apertures. In one embodiment, approximately 30% of the total luminous flux reflected from the reflective internal surface of the housing of the lighting device leaves the electric lighting device via the apertures for a given time period. In other embodiments, about 5%, 10%, 15%, 20%, 25%, 35%, 40%, 45%, or 50% of the total luminous flux reflected from the reflective internal surface of the housing of the lighting device leaves the electric lighting device via the apertures for a given time period.

It will be appreciated by a person skilled in the art that the actual percentage of the total luminous flux reflected from the reflective internal surface of the housing of the lighting device that leaves the electric lighting device via the apertures for a given time period will depend on the physical arrangement of the housing and the particular application, but that different percentages up to 65% can be utilised without departing from the spirit and scope of the present disclosure. Thus, photons leaving the lighting device have generally been reflected within the cavity of the housing of the lighting device before being emitted through an aperture in the second opaque portion.

Light passes from the cavity to the exterior of the housing through the apertures, which are of a size and arrangement to produce a narrowed light beam in a predetermined direction. In one embodiment, the sum of the area of the apertures occupies a minority of the internal surface of the housing of the lighting device. In one implementation, the sum of the area of the apertures occupies in the range of about 1% to 50% of the internal surface of the housing of the lighting device, wherein the internal surface of the housing defines an internal cavity with one or more reflective portions. In other implementations, the sum of the area of the apertures occupies in the range of about 10% to 30%, or 15% to 20%, or 20% to 40%, or 1% to 10%, or 5% to 15% of the internal surface of the housing of the lighting device. It is to be understood that when ranges such as the above are referred to in this disclosure, each amount within that range is disclosed as an embodiment. For example, the range of 15% to 20% discloses 15%, 16%, 17%, 18%, 19%, and 20% and all values in between. In one implementation, the sum of the area of the apertures occupies in the range of about 1% to 60% of an inner surface of the second opaque portion. In one embodiment, approximately 10% of the surface area of the second opaque portion corresponds to apertures, which corresponds to approximately 1% to 10% of the total surface area of the internal surface of the housing, depending on the size and shape of the housing. Other embodiments may utilise arrangements wherein the sum of the area of the of the inner surface of the second opaque portion. In such implementations, the majority of the light that is incident on the second opaque portion from within the cavity is reflected back into the cavity and only a relatively small proportion of the light from the cavity is transmitted through the apertures in the second opaque portion to the exterior of the housing. This produces a maximum randomisation of light within the cavity, so that light transmitted through the apertures appears to emanate from a uniform source. The light can be further controlled by the positioning, arrangement, and optical properties of the lens unit, which is aligned with the apertures to receive light transmitted through one or more of the apertures. The reflective cavity allows a lantern containing a small number of light sources to have the desirable appearance of having a much larger number of apparent light sources.

In one embodiment, the light source is positioned within the cavity so that light emitted from the light source is directed to be incident on the reflector provided by the first opaque portion of the housing. This is done to maximise the reflectance within the cavity.

An electric lighting device in accordance with the present disclosure can be adapted for use in many applications, such as, for example, street lighting, vehicular headlights and tail-lights, beacons, operating theatres, traffic signal lanterns, floodlights, and torches.

In one embodiment, the first opaque portion of the housing is a reflective body and the second opaque portion of the housing is a perforated cover, wherein the cover is coupled to the body. In one implementation, the cover is integrally formed with the body.

In another embodiment, the first opaque portion of the housing provides a reflector by having a reflective inner surface directed towards the cavity defined by the interior of the hollow structural housing. The reflective inner surface may be adjacent to an interior of the housing or form a part of the internal surface of the housing. In one implementation, a multi-faceted surface of the first opaque portion provides the reflective inner surface. Each facet of the multi-faceted surface functions as a substantially specular reflector, but the multi-faceted surface, as a whole, functions as a substantially diffuse reflector.

Alternatively, the reflective inner surface may be within the first opaque portion of the housing. In a further implementation, the first opaque portion is formed from a translucent material with a reflective backing, such that light from the cavity passes through the translucent material, is incident on the reflective backing surface and is then reflected back towards the cavity. The reflective surface can be specularly reflective, diffusively reflective, or a combination thereof. The reflective backing may be formed by using the known optical phenomenon of total internal reflection, in which the boundary between materials of different refractive indices may act as an efficient reflector. This type of reflector does not require the addition of any extra reflective materials or surface treatment. Alternatively, the translucent or transparent material may have reflective regions disposed within the material.

In a further embodiment, an inner surface of the second opaque portion of the housing is reflective. Light incident on the inner surface of the second opaque portion and which does not pass through one of the plurality of apertures is reflected back into the cavity. The inner surface of the second opaque portion can be specularly reflective, diffusely reflective, or a combination thereof. In an alternative embodiment, an inner surface of the second opaque portion of the housing is not reflective. In one implementation, a pattern of apertures is created by screen-printing or pad-printing the inner surface of the second opaque portion in a predetermined manner. In another implementation, a pattern of apertures is created by moulding the inner surface of the second opaque portion in a predetermined manner.

In another implementation, an inner part of the lens may be coated with a reflective metal by the processes of vacuum deposition, electroless plating, electroplating, or a combination of these methods. The apertures may be formed by a subtractive process, such as etching defined areas with acids or other etchants. In this case, the parts to be left un-etched may be coated with an etch resistant material, which may, for example, be a polymer or a noble metal. The etch resistant material may be subsequently removed by using solvents or other methods. The apertures may be formed by an additive process, in which the reflective coating is applied only to the areas outside the apertures. A combination of these techniques could be also be utilised.

In one embodiment, an exterior surface of the second opaque portion is adapted to be substantially non-reflective. For example, the exterior surface of the second opaque portion may be painted black or textured to minimise reflectance, or a combination thereof. This is to minimise light incident on the exterior surface of the second opaque portion, such as from an external light source, from being reflected back through the lens unit. For example, if the electrical lighting device is a traffic signalling lantern or is used in conjunction with a traffic signalling environment, it is desirable to minimise any exterior light from being reflected by the exterior surface of the second opaque portion of the housing. Such exterior light may include, for example, light received from the sun or from vehicle headlights. This is to minimise the chance of such reflected light resulting in a false signal.

Electrical lighting devices in accordance with the present disclosure can be utilised for many different applications. Accordingly, the shape and configuration of the electrical lighting devices can take many forms. In particular, the hollow structural housing can be implemented using many shapes, including, for example, but not limited to: conical or substantially conical; hemi-spherical or substantially hemi-spherical; spherical or substantially spherical; and cylindrical or substantially cylindrical. Further, the internal surface of the housing can be shaped to define different shaped cavities. For example, the internal surface of the housing can define a cavity that is spherical, parabolic, frusto-conical, cylindrical, or rectangular. In some applications, the shape of the electrical lighting device substantially resembles a conventional light globe or a fluorescent tube, which allows an electrical lighting device in accordance with the present disclosure to be retro-fitted into existing lighting arrangements.

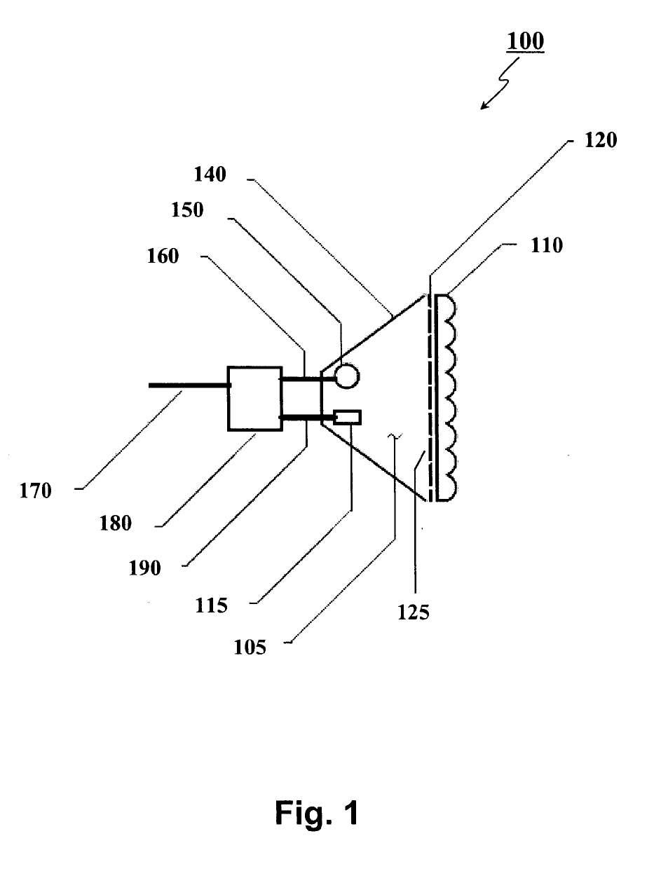

FIG. 1 illustrates an embodiment of an electric lighting device 100 in accordance with the present disclosure. The electric lighting device 100 includes a hollow structural housing formed by a body 140 and a cover 120. Internal surfaces of the body 140 and the cover 120 define a cavity 105. The body 140 forms a first opaque portion of the housing and has a diffuse reflective inner surface adapted to reflect light towards the cavity 105. The cover 120 forms a second opaque portion of the housing and has a plurality of apertures. In this example, the cover 120 is a perforated plate of opaque material. In an alternative embodiment, an inner surface of the cover 120 is screen-printed, silk-screened, electro-plated, moulded, or otherwise manufactured to provide a substantially opaque surface with a plurality of apertures between the interior of the housing and an exterior of the housing. In one embodiment, the inner surface of the cover is specularly reflective, diffusely reflective, or a combination thereof.

At least one light-emitting diode (LED) light source 150 is disposed within the cavity 105. In one embodiment, a plurality of LEDs are arranged in a predetermined pattern. In one embodiment, each light source is mounted or otherwise coupled to a rear surface of the body 140. The electric lighting device 100 also includes a lens unit 110 that is aligned with respect to the plurality of apertures in the cover 120. The lens unit 110 includes one or more lenses or lens elements to focus and modify light emitted from the apertures in the cover 120. In this example, the one or more lenses on the lens unit 110 are adapted to focus light emitted from the apertures in the cover 120 and to expand the area of the individual light sources 150.

In one embodiment, the lens unit includes a plurality of lenses or lens elements, wherein the lenses or lens elements are sufficiently closely spaced that the lenses or lens elements can be merged to form a lens plate, as shown in FIG. 1. The characteristics, positioning, and number of lenses on the lens unit 110 are determined by the particular application and the particular type of lighting characteristic that are desired. The lenses may be of a spherical or substantially spherical form or may be aspherical. In one implementation, each lens is an elongate half cylinder, with a plurality of half cylinder lens arranged abutting each other. In one implementation, the lens unit is formed from a moulding process. The exact shape of the lenses on the lens unit 110 can be chosen, for example, using Fermat's least time principle or Snell's law or by ray tracing. All these techniques are well understood by those skilled in optical design.

The shape and location of the apertures depends on the particular application of the electrical lighting device. The apertures may, when used in a traffic lantern embodiment, have a size in the range of approximately 0.5 mm² to 10 mm². The apertures may, for example, be arranged in a substantially regular pattern across some or all of the second opaque portion of the housing. Alternatively, the apertures may be arranged in any predetermined pattern, including a random pattern. The apertures may, for example, be round or rectangular or toroidal. In one implementation, the cover 120 includes a plurality of elongate, rectangular apertures, wherein each aperture is approximately 1 mm×2 mm. In this example, the sum of the area of the apertures occupies up to 50% of the inner surface of the cover 120. In one implementation, the sum of the area of the apertures occupies approximately 10% of the inner surface of the cover 120, corresponding to approximately 1% to 10% of the total surface area of the internal surface of the housing. In one implementation, the sum of the area of the apertures occupies approximately 4% of the total surface area of the internal surface of the housing. In such an implementation, the majority of the light that is incident on the cover 120 from within the cavity 105 is reflected back into the cavity 105 and only a relatively small proportion of the light from the cavity is transmitted through the apertures in the cover 120. This produces a maximum randomisation of light within the cavity, so that light transmitted through the apertures appears to emanate from a uniform source.

One embodiment of the electric lighting device 100 optionally includes a light sensor 115 disposed within the cavity 105 for measuring light flux within the cavity 105. A further embodiment of the electric lighting device 100 includes a controller 180 coupled to the at least one LED light source 150 and the light sensor 115 in order to control power delivered to the at least one light source 150. The controller 180 is coupled to the light source 150 via a first connection means 160 and is coupled to the light sensor 115 via a second connection means 190. The controller 180 is further coupled to an external power supply via power connection means 170. In one embodiment, the controller is implemented using a microprocessor and control software executed by the microprocessor. This feedback control mechanism would be well understood by a person skilled in the art of electrical and electronic and control engineering.

The controller 180 can be used to set the cavity light flux to a fixed value, which is independent of temperature or light source efficiency, by controlling an amount of power supplied to the light source 150. In another embodiment, the controller 180 and the light sensor 115 are utilised to adjust the light flux in the cavity to be a function of the supply voltage to the lantern. In another embodiment, the light sensor 115 is omitted and the light source power is made constant. In another embodiment, the light sensor 115 is omitted and the light source power is made to be a function of the supply voltage of the lantern. The accurate use of the light sensor 115 is possible because the light flux within the optical cavity is affected strongly by the amount of light emitted from the light source 150 and the total area of the perforations in the perforated reflector plate. The light flux within the cavity is less affected by the external ambient light.

The body 140 that provides the reflector in the interior of the housing and the perforated reflector plate 120 in FIG. 1 may be of a diffusely reflecting kind, though a specular reflecting textured surface may equally be used. The perforated reflector plate is 120 may be specularly reflective. The surface of the perforated reflector plate 120 facing the optical cavity is the reflecting surface. The reverse surface of the reflector plate 120 facing the exterior of the housing may be made non-reflecting to reduce phantom illumination of the electrical device when used for signalling purposes. The cover 120, implemented in this example as a perforated reflector plate, may be formed on a surface of the lens unit 110 by metal deposition, screen printing, or other coating processes. Alternatively, the cover 120 and lens unit 110 may be separate components adjacent to each other or coupled to each other.

The present disclosure provides an electric lighting device, for example in the form of a lantern, containing a small number of light sources that has a desirable appearance of having a much larger number of apparent light sources.

A lighting device in accordance with the present disclosure provides better control of the direction of the light from the lantern when compared with the use of individual LEDs, through the suitable selection of the second opaque portion of the housing and the physical properties of the lens unit. This allows the use of embodiments of the present disclosure in various disparate signalling and illumination applications.

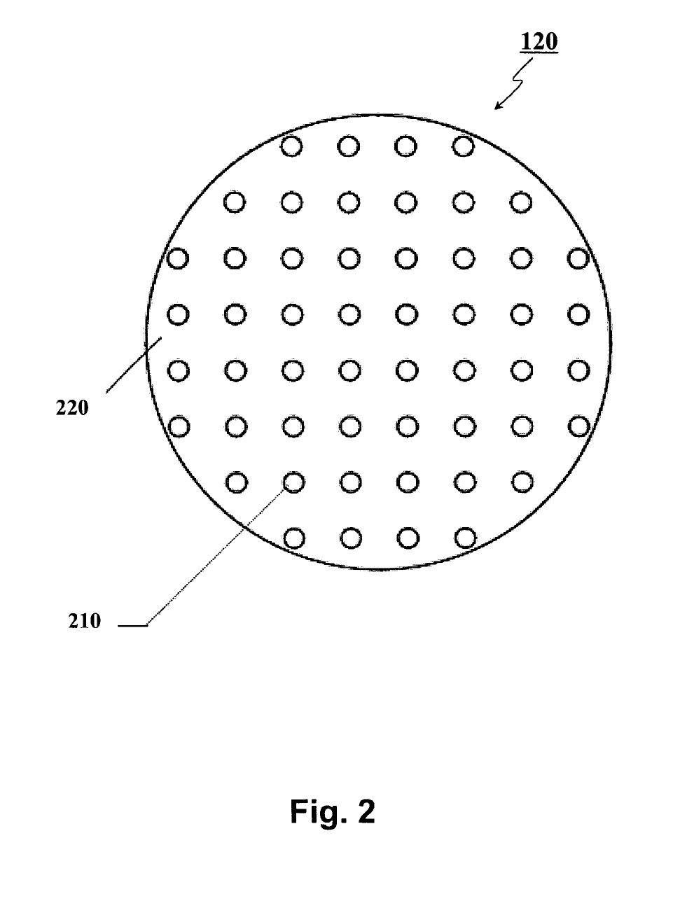

Returning to FIG. 1, the electrical device 100 includes a cover 120 constituting a second opaque portion of the housing having a plurality of apertures. The cover 120 is implemented in the form of a perforated reflector plate 120. FIG. 2 shows one embodiment of a perforated reflector plate 120. The reflector plate 120 includes a plurality of apertures 210 that permit transmission of light from one side of the reflector plate 120 to the other side of the reflector plate 120. The apertures 210 in the perforated plate 120 are here shown as circular in shape, though apertures of different shapes and configurations may equally be practised. The sum of the area occupied by the apertures 210 is generally less than half of the total surface area of the surface 220 of the perforated plate 120. As described above, the reflector plate 120 is one implementation of a second opaque portion of a housing of the electrical device of the present disclosure. The second opaque portion may equally be practised by screen-printing, electroplating, or moulding apertures on a relevant portion of the housing.

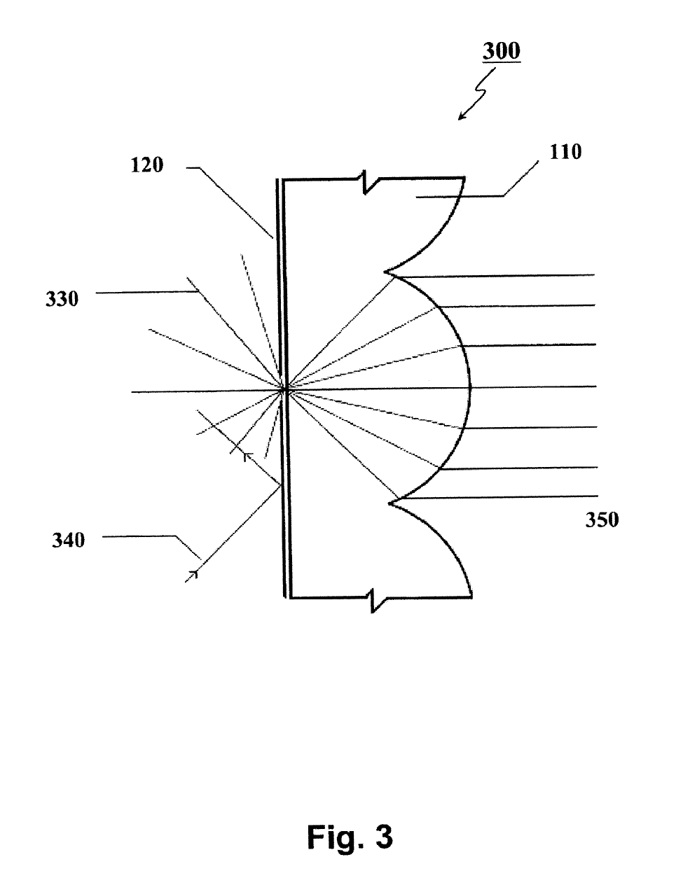

FIG. 3 illustrates typical paths of light rays within the optical cavity as the light rays impinge upon the reflector plate 120. In the arrangement shown in FIG. 3, the lens plate 110 is positioned adjacent to the reflector plate 120. Light rays 330 pass through an aperture in the perforated reflector plate 120 and are refracted, as those light rays 330 enter the lens unit 110, according to Snell's law and are again refracted as those light rays 330 leave an exterior front surface of the lens plate 110. The properties of the lens unit 110, such as the alignment of the lens unit 110 relative to the aperture, transmissive properties, and radius of curvature, for example, produces a narrow beam of light 350. Light rays 340 that do not pass through an aperture in the perforated plate 120 are reflected back into the optical cavity 105 to contribute to the luminous flux within the optical cavity 105. Though FIG. 3 illustrates a well-focused beam, as would be produced by a spot light, it is clear that by suitable choice and alignment of lens focal length and perforated reflector plate aperture size, a flood light characteristic could equally be produced. In particular, use of a larger aperture size and a lens with a longer focal length would produce such a floodlight characteristic.

The interior cavity of the lighting device is arranged to affect the radiation from the light source(s), so that the radiation arrives substantially isotropically at each aperture, or part thereof. That is, the light radiation arrives uniformly from every direction. This can be achieved by making the internal surface of the housing of the lighting device highly diffusively reflective. For ease of manufacture or otherwise, a reflective textured surface or rugose surface may be used to achieve the same end. Similarly, some parts of the internal surface of the housing that defines the cavity may be specularly reflective and still achieve the required result. Where a flat or substantially flat lens unit is used, regions of the inner surface of the second opaque portion of the housing around the apertures may be made specularly reflective or diffusively reflective, without changing the overall characteristics of the device. In order to achieve maximum uniformity of radiation reaching the apertures, one or more baffles made of reflective material may be disposed within the cavity to shield the apertures from any direct radiation emitted from the light source(s) or from non uniformly illuminated regions of the reflector.

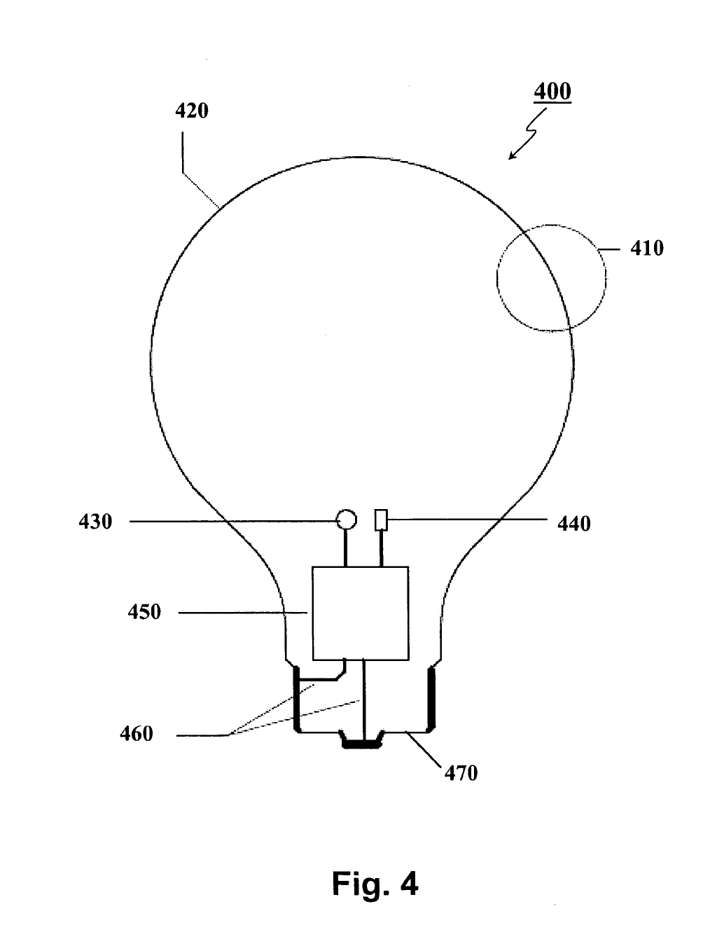

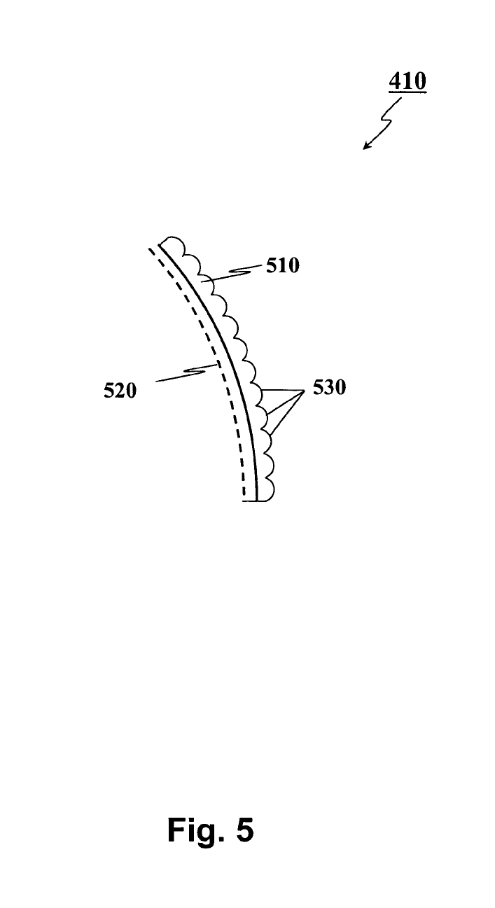

FIG. 4 shows an electric lighting device 400 in accordance with an embodiment of the present disclosure, wherein the electric lighting device includes a hollow structural housing 420 shaped to conform to a spherical shape envelope of a conventional light bulb. The electric lighting device 400 includes a light source 430, a light sensor 440 and a controller 450, each of which is disposed within a cavity defined by an internal surface of the housing 420. The controller 450 is connected to electrical contacts 470 of the light bulb device by electrical conductors 460. A circle identifies a typical region 410 of the housing 420, which is shown in an expanded view in FIG. 5. Embodiments of the present disclosure may equally be practised in a variety of shapes, including those corresponding to convention light bulbs or conventional fluorescent tubes.

FIG. 5 shows an expanded view of a cross section of a region 410 of the housing 420 of the light bulb illustrated in FIG. 4. The region 410 shows a reflective surface 520 having a plurality of apertures that allow light to be transmitted from an interior of the housing 420 to the exterior of the housing. In the embodiment shown, a lens unit 510 includes a plurality of lens elements 530, wherein the lens unit 510 is aligned with the plurality of apertures in the reflective surface 520. The lens unit 510 and reflective surface are arranged to correspond to the form of the light bulb.

In one embodiment of the arrangement shown in FIGS. 4 and 5, a plurality of apertures are provided over a first region of an inner surface of the housing 420 and the lens unit 510 covers a corresponding first region of an exterior surface of the housing 420. In the example in which the first region of the inner surface covers all, or substantially all of the inner surface, the electric lighting device emits light in all directions. In such an arrangement, a reflective coating on the inner surface of the housing performs as a first opaque portion of the housing providing a reflector in the interior of the housing and a second opaque portion of the housing having a plurality of apertures between the interior and exterior of the housing. In another example in which the first region corresponds to a relatively small portion of the inner surface, the electric lighting device emits light in a directed manner, dependent on the lens unit.

One implementation of the lighting device shown in FIG. 1 includes a lens unit 110 constructed using an injection moulding process. A suitable material for the lens plate has high light transmission properties, as exhibited by optical grades of polycarbonate plastic. A suitable grade of LEXAN™ polycarbonate resin thermoplastic, as produced by SABIC Innovative Plastics, would be appropriate. In one arrangement, the perforated reflector plate is screen printed onto an inner surface of the lens unit 110 using usual screen printing methods. One particular implementation utilises a white reflecting ink.

One embodiment utilises a lens unit that is integral with the second opaque portion of the housing of a lighting device. This may be achieved by screen printing a reflective material onto an inner surface of the lens unit, with apertures formed by not applying reflective material to discrete regions of an inner surface of the lens unit. Alternatively, an integral lens unit and aperture plate can be formed by an in mould decoration (IMD) process, in which the aperture plate is moulded and then the lens unit is overmoulded onto the aperture plate. The second opaque portion of the housing can equally be manufactured by coating or plating one side of the lens unit with a reflective material, including a metal, then selectively etching apertures where required. Alternatively, the second opaque portion of the housing can equally be manufactured by selectively coating one side of the lens unit with a reflective material while avoiding coating the apertures. As mentioned above, pad printing can also be used in the manufacture of the second opaque portion of the housing by applying a pattern onto the lens unit. Pad printing uses a conformable pad, such as a pad made from silicon rubber, to pick up an image and deposit the image onto the work. A further method of manufacturing the second opaque portion integral with a lens unit utilises hot stamping, in which a thin plastic, possibly metalized, film containing reflective parts and apertures is pressed onto the lens unit and made to adhere by use of heat and pressure.

One mode of manufacturing the lens unit utilises injection moulding, which enables thin, low cost lens units to be manufactured for replacement tubular lamps, as the thinner plastic may be conformable to form cylindrical surfaces. Injection moulding of thicker lens units can be utilised for applications with impact or load requirements, such as airport landing lights.

Another mode of manufacturing the lens unit involves machining the lens unit from solid material. This would be appropriate for very thick lenses. Another mode of manufacturing the lens unit involves embossing the one or more lenses or lens elements onto sheet material. Such a mode of manufacture is appropriate for very thin lenses, and utilises an embossing roller. Embossing may be utilized on continuous sheet material, and it is possible to apply contemporaneously a plurality of apertures using a continuous printing method. Alternatively, embossing could be performed at the same time as fusing a reflective sheet containing apertures.

The lens unit is easily scalable and is limited on the small side by wavelength effects and precise location of the apertures and on the large size by material properties. Injection moulding is suitable for thicknesses of a few millimeters. For larger lenses, casting with transparent materials or machining from solid is more appropriate. Three-dimensional (3D) printing is a further, though generally most costly, option for forming a lens unit.

As described above, one embodiment of a lighting device in accordance with the present disclosure is a traffic light. A preferred shape for a traffic light is for the housing to have an internal surface defining a substantially cylindrical cavity, with the lens unit placed on and covering one circular end of the cylindrical cavity. The two substantially circular ends of the substantially cylindrical cavity may not be parallel. In one embodiment, the light emitting end is tilted by approximately 5 degrees, so as to be more readily viewable by drivers of vehicles. The light source in this example is implemented using one or more LEDs and is placed behind an optional baffle so that light from the one or more LEDs hits a diffusely reflecting surface before encountering the lens unit.

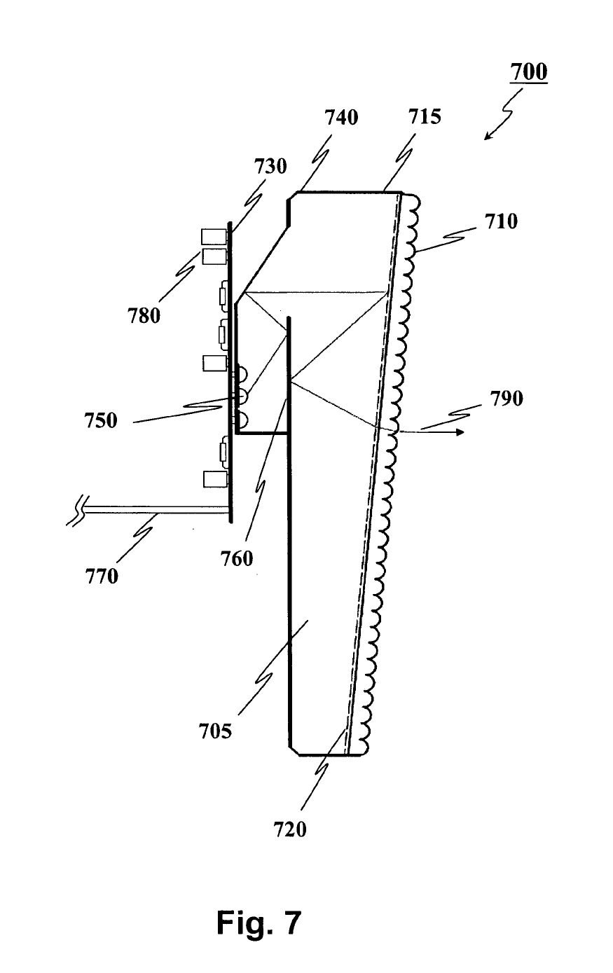

FIG. 7 shows a cross-section of a traffic signal lantern 700 embodying an electric lighting device in accordance with the present disclosure. The traffic signal lantern 700 includes a hollow structural housing 715. An internal surface of the housing 715 defines a cavity 705. The traffic signal lantern 700 also includes a light source 750, which in this example is implemented using three LEDs. Depending on the application, a plurality of LEDs may be utilised in implementing the light source 750. The plurality of LEDs may be arranged, for example, in a linear pattern, a rectangular array, or any regular or irregular configuration to provide a light source appropriate for the housing 715.

A first portion 740 of the housing 715 is opaque to visible light and provides a reflector in the interior of the housing 715. That is, light that is incident on the first portion 740 from within the cavity 705 is not able to pass through the first portion 740 and that light is reflected back into the cavity 705. As described above, the reflector may be implemented by virtue of the first portion 740 possessing a different refractive index from the cavity 705, resulting in internal reflection within the cavity 705. Alternatively, the first portion may provide the reflector by virtue of a reflective coating or textured surface applied to the interior surface of the housing 715 or within the first portion 740. In a further alternative, a reflective coating or textured surface is applied to an exterior surface of the first portion 740 to reflect light back into the cavity 705.

The housing 715 further includes a second portion 720 that is opaque to visible light. The second portion 720 includes a plurality of apertures that allow light to pass from the cavity 705 on the interior of the housing 715 to the exterior of the housing 715. The second portion 720 may be implemented by using a perforated plate, such as that described above with reference to FIGS. 1 and 2. As described above, further implementations of the second portion may equally be practised, such as an inner surface of the second portion 720 being screen-printed or pad-printed to realise a predetermined arrangement of apertures. The inner surface of the second portion 720 is optionally a reflective surface, by virtue of the second portion 720 possessing a different refractive index from the cavity, resulting in internal reflection within the cavity. Alternatively, the second portion 720 may be reflective towards the cavity 705 by virtue of a reflective coating or textured surface applied to the interior surface of the housing 715 corresponding to the second portion 720 or within the second portion 740. In a further alternative, a reflective coating or textured surface is applied to an exterior surface of the second portion 720 to reflect light back into the cavity 705.

The traffic signal lantern 700 also includes a lens unit 710 adjacent to the second opaque portion 720. In this example, the lens unit 710 includes a plurality of substantially spherical lens elements, wherein each lens element is aligned with a corresponding one of the plurality of apertures in the second portion 720. As described above, the lens unit 710 can be coupled to the second opaque portion 720 or alternatively the lens unit 710 and second opaque portion may be integrally formed with one another.

As shown in FIG. 7, in this example the second portion 720 of the housing 715 and the lens unit 710 are angled slightly downward, in the range of approximately 2 degrees to 20 degrees, to enable light emitted from the traffic signal lantern 700 to be seen more easily by road users at street level.

The traffic signal lantern 700 further includes, in this example, an optional baffle 760 disposed within the cavity 705. The baffle 760 is positioned relative to the light source 750 such that light emitted from the light source 750 is incident on at least one surface within the housing 715 before passing through an aperture of the second opaque portion 720. The baffle may be integrally formed with the housing 715, such as through an injection moulding process. Alternatively, the baffle 760 is disposed within the cavity 705, through coupling to an internal surface of the housing 705, or some other means.

FIG. 7 shows a light trace 790 of a light photon emitted from the light source 750. In the example shown, light emitted from a second one of the three LEDs in the light source 750 is incident on the baffle 760 and is reflected to be incident on the first opaque portion 740 of the housing 715. The light 790 is reflected to be incident on the second opaque portion 720, whereupon the light 790 is reflected back towards the cavity 705. The light 790 is then incident on the baffle 760 before being reflected back towards the second opaque surface 720. In this example, the light 790 passes through one of the plurality of apertures in the second opaque portion 720 and passes through a corresponding lens element in the lens unit 710 to be emitted to an exterior of the traffic signal lantern 700.

The example of FIG. 7 further shows power supply lines 770 for coupling the traffic signal lantern 700 to an exterior power supply. The power supply lines 770 are coupled to a printed circuit board 730. The light source 750 is also coupled to the printed circuit board 730. Various other electronic components 780 may be coupled to the printed circuit board 730, such as resistors, capacitors, transformers, and the like.

The traffic signal lantern 700 optionally includes a light sensor (not illustrated) disposed in the cavity 705, as described above. Further, light emitted from the light source 750 may be controlled by a controller (not illustrated) coupled to the power supply, the light source 750 and the light sensor. The controller may be implemented, for example, by utilising a microprocessor coupled to the printed circuit board 730 or alternatively the controller may be located remotely and coupled to the traffic signal lantern 700. The controller may, for example, be coupled to the traffic signal lantern via a wired or wireless transmission medium.

One embodiment of the traffic signal arrangement includes a light source having 6 LEDs. High output luminaire arrangements in accordance with the present disclosure utilise substantially more LEDS. For example, a 10000 lumen street light implemented is using an electric lighting device of the present disclosure utilises 100 LEDs. Because of the uniform mixing of light from the plurality of sources, the LEDs may be different colours or types and will produce a final uniform colour, depending on the particular mix of individual LED colours chosen and further dependent upon which LEDS are being driven at a given time. This feature may be used to “trim” the colour output by the lighting device to some preferred colour or hue, or to select the displayed colour. In scenarios that demand high reliability, the ability to use disparate light generating technologies provides a safety or reliability benefit.

One application utilises a plurality of electric lighting devices arranged in an array to act as a display panel. One implementation controls each one of the electric lighting devices independently, wherein each lighting device functions as a pixel in an array. Text and graphics can then be displayed by controlling each lighting device pixel. In another implementation, groups of one or more electric lighting devices are controlled as sub-arrays. The array of lighting devices can arranged in any shape, including a rectangular array, a triangular-shaped array, a diamond-shaped array, or any regular or irregular shape, depending upon the application. When implemented using LEDs of different colours, a colour display is realisable. Such a display panel may be utilised for many purposes including, for example, to provide textual or graphic traffic warnings when positioned proximate to a road, to display advertising material, or to broadcast video or still images.

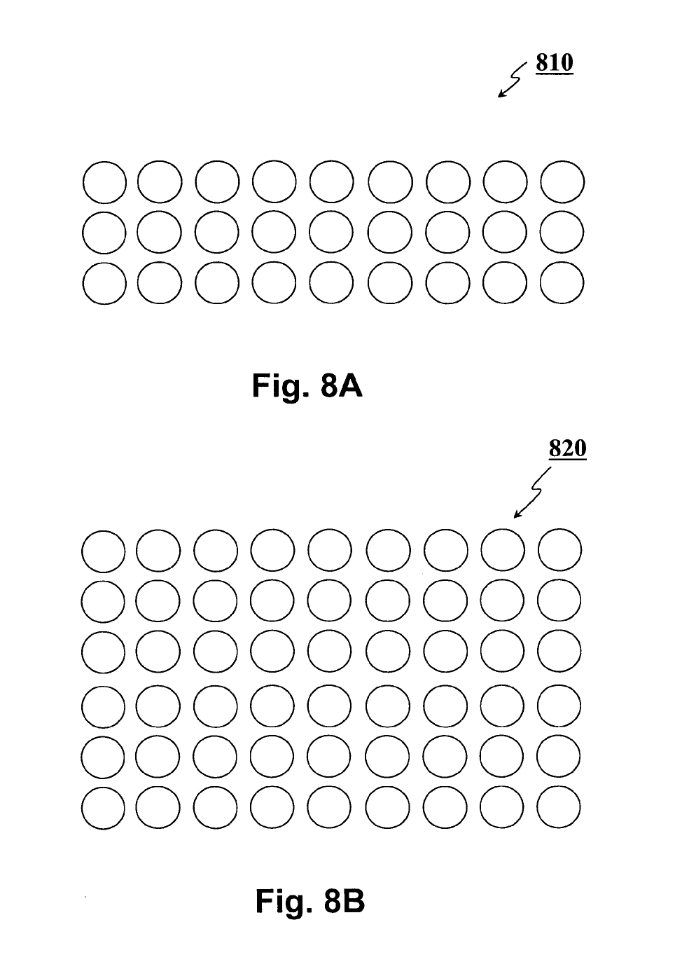

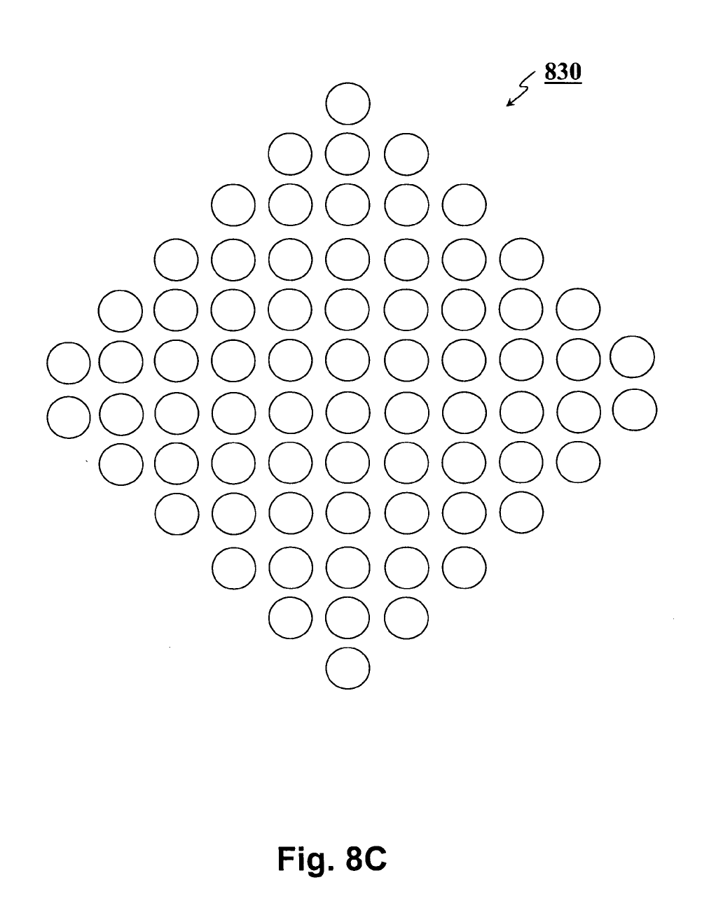

FIGS. 8A to 8C illustrate embodiment of electric lighting devices arranged in arrays to act as display panels. In these embodiments, each lighting device appears to be substantially circular in shape, but other shapes may equally be practised, depending on the particular application. For example, lighting devices with frontal shapes in the form of rectangles, FIG. 8A shows a rectangular array 810 of lighting devices adapted for use as a ticker-tape style display, wherein text scrolls across the display by controlling each of the individual lighting devices. FIG. 8B shows a rectangular array 820 of lighting devices adapted for use as a general display for text and graphics. FIG. 8C shows a substantially diamond-shaped array 830 of lighting devices adapted for use as a warning sign. Other arrangements of lighting devices in accordance with the present disclosure may equally be practised.

Embodiments of the present disclosure can be implemented using light emitting diodes, including high output LEDs. Such LEDs include XLamp LEDs produced by CREE, Inc. The light source may be implemented using one or more LEDs. The first opaque portion of the housing may be implemented using a reflective body, as shown in FIG. 1, which may be injection moulded from an opaque grade of polycarbonate plastic and then coated with a diffuse reflecting paint. The reflecting surface may contain highly reflecting materials such as polytetrafluoroethylene (PTFE), titanium dioxide, or barium sulphate. The light sensor 115 of FIG. 1 can be implemented using a BPW21R photodiode, made by VISHAY Intertechnology. Implementations of the controller 180 may be of a conventional kind that includes a combination of one or more power supplies and feedback control means of a common kind easily designed by a person skilled in the arts of power supply design and closed loop control.

Embodiments of the present disclosure can be applied to make replacement lamps, such as the sealed beam lamp parabolic aluminumized reflector 38 (PAR38) type, with either the flood light or spotlight characteristic.

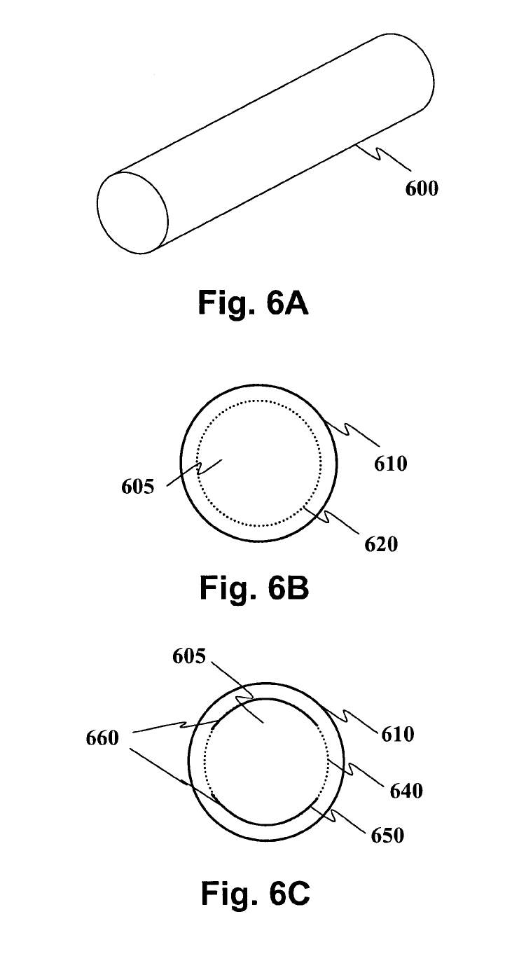

FIG. 6A shows a perspective view of an electric lighting device 600 in accordance with the present disclosure. In the example of FIG. 6, the electric lighting device 600 is is shown having a hollow structural housing 610 in the form of a conventional fluorescent light bulb, which is an elongate cylinder.

FIG. 6B shows a cross-sectional view of one implementation of the electric lighting device 600, in which an internal surface 620 of the housing 610 defines a cavity 605. The internal surface 620 includes a plurality of apertures that allow light to be transmitted from the cavity 605 to an exterior of the housing. Light in the cavity is derived from a light source disposed within the cavity 605 at some point or points along the elongate cylinder. For clarity purposes, the light source is not shown in this example.

FIG. 6C shows a cross-sectional view of another implementation of the electric lighting device 600, in which an internal surface 650 of the housing 610 defines a cavity 605. First portions 660 of the internal surface 650 provide a reflective surface to reflect light back into the cavity 605. Second portions 640 of the internal surface 650 include a plurality of apertures that allow light to be transmitted from the cavity to an exterior of the housing. Light in the cavity is derived from a light source disposed within the cavity at some point or points along the elongate cylinder. For clarity purposes, the light source is not shown in this example.

The examples of FIGS. 6A to 6C illustrate the flexibility of a lighting device in accordance with the present disclosure. Different shaped housings and cavities allow embodiments of the lighting device to be compatible with existing lighting facilities. Further, allocating different portions of the housing to act as the first and second opaque portions described above allows greater control over light emanating from the electric device.

Embodiments of the present disclosure can be applied in signalling applications, such as in a traffic or railway lantern, when made using the spotlight-like, well-focussed characteristic. In one embodiment, an electric lighting device in accordance with the present disclosure is adapted for coupling to a traffic signalling device.

Further embodiments of the present disclosure can be applied in street lighting, when built with a characteristic light distribution pattern to give good illumination over a well defined large area. This is achieved by proper choice of perforated reflector plate and lens characteristic.

### INDUSTRIAL APPLICABILITY

The arrangements described are applicable to the electrical and lighting industries and particularly for traffic signalling and vehicular guidance industries.

The foregoing describes only some embodiments of the present invention, and modifications and/or changes can be made thereto without departing from the scope and spirit of the invention, the embodiments being illustrative and not restrictive.

1. An electric lighting device, comprising:
a hollow structural housing having an internal surface defining a cavity;
a light-emitting diode (LED) light source disposed within said cavity in the interior of said housing;
a first opaque portion of said housing adapted to provide a reflector in the interior of said housing, a second opaque portion of said housing having a plurality of apertures between the interior and exterior of said housing; and
a lens unit aligned with said plurality of apertures.

2. The electric lighting device according to claim 1, wherein said first opaque portion of said housing is a reflective body and said second opaque portion of said housing is a perforated cover, said cover being coupled to said body.

3. The electric lighting device according to claim 2, wherein said cover is integrally formed with said body.

4. The electric lighting device according to claim 1, wherein an inner surface of said first opaque portion of said housing is at least one or specularly reflective and diffusely reflective.

5. The electric lighting device according to claim 1, wherein an inner surface of said opaque portion of said housing is at least one of specularly reflective and diffusely reflective.

6. The electric lighting device according to claim 1, wherein said housing is selected from the group of shapes consisting of: conical or substantially conical; hemi-spherical or substantially hemi-spherical; spherical or substantially spherical; and cylindrical or substantially cylindrical.

7. The electric lighting device according to claim 1, wherein said lens unit includes a plurality of lens elements.

8. The electric lighting device according to claim 7, wherein each one of said plurality of apertures in said second opaque portion of said housing is aligned with at least one of said plurality of lens elements.

9. The electric lighting device according to claim 1, wherein said lens unit is integrally formed with an exterior surface of said second opaque portion of said housing.

10. The electric lighting device according to claim 1, wherein said lens unit is coupled to said housing.

11. The electric lighting device according to claim 1, further comprising a light sensor for measuring light in said cavity.

12. The electric lighting device according to claim 11, further comprising a controller coupled to said at least one LED light source and said light sensor, said controller dependent on said light sensor to control power supplied to each one of said at least one light source.

13. The electric lighting device according to claim 1, wherein said plurality of apertures are arranged in a substantially regular pattern.

14. The electric lighting device according to claim 1, wherein said second opaque portion of said housing is a perforated plate forming an opaque reflective surface on a portion of said internal surface of said housing, perforations in said plate forming said plurality of apertures between the interior and exterior of said housing.

15. The electric lighting device according to claim 1, wherein said housing is adapted for coupling to a traffic signaling device.

16. The electric lighting device according to claim 1, wherein said housing is formed in the shape of a conventional light globe.

17. The electric lighting device according to claim 1, adapted for use as a traffic signaling lantern.

18. The electric lighting device according to claim 1, wherein each of said plurality of apertures is in the range of approximately 0.5 mm² to 10 mm².

19. The electric lighting device according to claim 1, wherein a sum of the areas of the apertures is in a range of up to 50% of the surface area of an inner surface of said second opaque portion of said housing, and includes a range of 0.5% to 20%.

20. A lighting device, comprising:
a hollow structural housing having an internal surface defining a cavity;
a light source disposed within said cavity in the interior of said housing;
a first opaque portion of said housing adapted to provide a reflector in the interior of said housing, a second opaque portion of said housing having a plurality of apertures between the interior and exterior of said housing; and
a lens unit aligned with said plurality of apertures.

21. The electric lighting device according to claim 19, wherein said lighting device is electric and said light source is implemented using at least one of a light-emitting diode, light emitting plasma, a tungsten filament, and an optical fibre.
